(19) United States
(12) Patent Application Publication
(10) Pub. No.: US 2012/0103770 A1
(43) Pub. Date: May 3, 2012

(54) Apparatus for Using Handheld Devices

(76) Inventor: Peter Q. Warinner, Belmont, MA (US)

(21) Appl. No.: 12/938,354

(22) Filed: Nov. 2, 2010

(51) Int. Cl. H01H 3/00

(52) U.S. Cl. 200/330

(57) ABSTRACT

An apparatus for using a handheld device is disclosed herein. As disclosed herein, an apparatus for using a handheld device includes a body and a member. The body is configured to conform to a digit of a user of the apparatus. The member is connected to the body adjacent to the user's digit, and is designed to transfer force from the user's digit to a responsive portion of a handheld device. The transfer of force from the user's digit to the responsive portion of the handheld device produces a desired input related to the handheld device.

### RELATED APPLICATIONS

None.

### FIELD

The presently disclosed embodiments relate to an apparatus for using handheld devices, and more particularly to an apparatus for improved user control of handheld devices.

### BACKGROUND

Handheld devices are used by billions of people worldwide. Competition in the handheld device consumer market is fierce. Companies continue to search for new handheld device designs to penetrate the tremendous handheld device market. Despite the large capital flows being used to design new and improved handheld devices, handheld devices continue to suffer from many shortcomings pertaining to their usability. In particular, the limited spacing available on handheld devices makes it difficult for handheld device manufacturers to design user friendly interfaces. Accordingly, there exists a need for an apparatus that can improve the user control over handheld devices without increasing the space currently available for the user interfaces.

### SUMMARY

An apparatus for using a handheld device is disclosed. In an embodiment, an apparatus for using a handheld device includes a body configured to conform to a digit, and a member connected to the body adjacent to the digit, wherein bringing the member into contact with the handheld device transfers force from the digit to the handheld device.

In an embodiment, an apparatus for using a handheld device includes a body configured to conform to a digit, the body having a proximal end, a distal end, and an opening between the proximal and distal ends for receiving the digit, and a member connected to the body adjacent to a distal portion of the digit, wherein when the digit moves the member into contact with the handheld device, the member transfers force from the digit to the handheld device.

In an embodiment, an apparatus for using a handheld device includes a body configured to conform to a digit, and a member connected to the body adjacent to a tip of the digit of the digit, the member being defined by a length and a cross-sectional area sufficient to allow the member to transfer force from the digit to the handheld device when the digit moves the member into contact with the handheld device.

In some embodiments, the member can be used to perform on the handheld device a gesture, typing, tapping, pressing, writing, drawing, painting, switching, sliding, texting, selecting, inputting, holding, or combinations thereof.

In some embodiments, the body further includes a covering at the distal end of the body to minimize displacement of the body from its position as conformed to the digit.

In some embodiments, the apparatus further includes one or more additional members situated on the body, wherein bringing each of the one or more additional members into contact with the handheld device transfers force from the digit to the handheld device to activate a responsive portion of the handheld device.

In some embodiments, the member is removable.

In some embodiments, the member is replaceable.

In some embodiments, the member is relocatable.

In some embodiments, the member is rotatable.

In some embodiments, the member is pivotable.

In some embodiments, the body extends from a sleeve or other article of clothing or clothing accessory of a user of the apparatus.

### BRIEF DESCRIPTION OF THE DRAWINGS

The presently disclosed embodiments will be further explained with reference to the attached drawings, wherein like structures are referred to by like numerals throughout the several views. The drawings shown are not necessarily to scale, with emphasis instead generally being placed upon illustrating the principles of the presently disclosed embodiments.

FIG. 1A shows a perspective view, of an embodiment, of the apparatus of the present disclosure. FIG. 1B shows a plan view of the apparatus of the present disclosure shown in FIG. 1A. FIG. 1C shows a side view of the apparatus of the present disclosure shown in FIG. 1A. FIG. 1D shows an end view of the apparatus of the present disclosure shown in FIG. 1A.

FIG. 2 shows a perspective view, of an embodiment, of the apparatus of the present disclosure being used to control a handheld device.

FIG. 3 shows a close-up perspective view, in accordance with an embodiment, of a member of the apparatus of the present disclosure being used to contact a responsive portion of a handheld device.

FIG. 4A shows a perspective view, of yet another embodiment, of the apparatus of the present disclosure. FIG. 4B shows a plan view of the apparatus of the present disclosure shown in FIG. 4A. FIG. 4C shows a side view of the apparatus of the present disclosure shown in FIG. 4A. FIG. 4D shows a distal end view illustrating a covering of the body of the apparatus of the present disclosure shown in FIG. 4A. FIG. 4E shows a proximal end view illustrating an opening of the body of the apparatus of the present disclosure shown in FIG. 4A.

FIG. 5 shows a perspective view, in accordance with another embodiment, of the apparatus of the present disclosure.

FIG. 6A shows a perspective view, of another embodiment, of the apparatus of the present disclosure. FIG. 6B shows a plan view of the apparatus of the present disclosure shown in FIG. 6A. FIG. 6C shows a side view of the apparatus of the present disclosure shown in FIG. 6A. FIG. 6D shows an end view of the apparatus of the present disclosure shown in FIG. 6A.

FIG. 7 shows a close up perspective view, in accordance with an embodiment, of the member of the apparatus of the present disclosure.

FIG. 8 shows a perspective view, of another embodiment, of the apparatus of the present disclosure.

FIG. 9A shows a perspective view, in accordance with an embodiment, of a rotatable member in a first position situated in a groove on the body of the apparatus of the present disclosure. FIG. 9B shows an alternative perspective view of the embodiment shown in FIG. 9A, illustrating the rotatable member in a second position situated in the groove on the body of the apparatus of the present disclosure.

FIG. 10A shows a perspective view of a member being connected to a body, in accordance with an embodiment, of the apparatus of the present disclosure.

FIG. 10B shows a perspective view of the member in FIG. 10A after being connected to the body, in accordance with an embodiment, of the apparatus of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

Consumers are increasingly relying on handheld devices to perform everyday tasks. For example, consumers use handheld devices for communicating (e.g., email, text-messaging, voice, data) with family, friends, and business contacts, daily planning (e.g., calendars, reminders), recreation (e.g., playing casual games, blogging, tweeting, listening to music, watching videos, and reading books), and GPS navigation, to name a few applications. Among the more popular handheld devices are mp3 players, digital book readers, smartphones, and touch phones, to name a few.

Handheld devices such as the IPOD®, the IPHONE®, the KINDLE®, and smartphones like the BLACKBERRY®, have transformed the way in which consumers carry out their everyday tasks. Among the driving forces behind the tremendous popularity of handheld devices, the convenience from the miniature size ranks high. However, the drive for miniaturization of handheld devices also is a source of major frustration and drawbacks for many handheld devices. In particular, handheld devices invariably require precise stroking of miniature keys that are often just fractions of a size of an average size digit. In addition, with the advent of touch screens, the sensitivity of touch keys and other various digit movements has made it more and more difficult for users to obtain desired responses without having to backtrack or delete, or otherwise correct for errors. Such difficulty in obtaining desired results when interacting with handheld devices is a common occurrence among average mainstream users of handheld devices. Imagine how much more frustrating it is for users with clumsy hands, limitations from debilitating diseases, such as carpal tunnel syndrome or neuromuscular disorders or arthritic disorders, or users with larger than average size digits. All of these factors slow down the speed and accuracy with which a handheld device user is able to obtain desired responses, such as in writing a text message.

In addition to challenges with interfacing with ordinary handheld devices, it is believed that frequent use of handheld devices requiring repetitive strokes with the thumb or other digit in a typically unnatural pattern can lead to increased occurrence of undesirable health outcomes, such as numbness in the hands or digits.

Without wishing to be bound by theory, it is also believed that users with varying degrees of physical limitation, such as those users with neuromuscular disorders or arthritic disorders, have reduced access to use of, or general difficulty using handheld devices.

Due to the limited spacing available on handheld devices to accommodate standard QWERTY keyboards, designing user interfaces (e.g. keypads or touch screens) having ergonomical designs to minimize injury to the user have been difficult.

Accordingly, there exists a need for an apparatus that can provide one or more of the following benefits:
(1) Improves speed for users of handheld devices;
(2) Improves accuracy for users of handheld devices;
(3) Improves ergonomics for users of handheld devices;
(4) Reduces injury associated with the use of handheld devices; or
(5) Increases access to use of (or ease of use of) handheld devices by users with varying degrees of physical limitation.

As used herein, “handheld device” refers those electromechanical devices which are intended to be, or are otherwise capable of being used with physical manipulations of the hand whether held in the hand or otherwise, including, but not limited to a smart phone, a cellular phone, a mobile phone, a messaging phone, a calculator, a tablet, a personal digital assistant, a digital or electronic book reader, an mp3 player, a multimedia player, a videogame console, a portable gps, and equivalents or combinations thereof.

As used herein, “responsive portion” refers to any input portion of a typical input/output paradigm for electromechanical devices as part of a user interface that allows a user to interact with the device so that physical manipulations of the input portion result in a unique ascertainable output initiated on the electromechanical device. Examples of responsive portions include, but are not limited to, a keyboard, a virtual keyboard, a digital keyboard, a keypad, a digital keypad, a virtual keypad, a key, a digital key, a virtual key, a touch screen, a touch pad, a touch key, an onscreen keyboard, an onscreen key, an icon, an application icon, a button, a digital button, a virtual button, a touch screen button, a data entry field, a digital data entry field, a virtual data entry field, an alphanumeric key, a symbol, a virtual symbol, a digital symbol, and equivalents or combinations thereof.

As used herein, “gesture” refers to a tap, a swipe, a drag, a flick, a pinch, and equivalents or combinations thereof.

As used herein, “digit” refers to a thumb, a pointer finger, a middle finger, an index finger, or a pinky finger of a user of a handheld device. Alternatively, “digit” may refer to a toe.

In an embodiment, an apparatus of the present disclosure is provided for improving user control of a handheld device. In an embodiment, an apparatus of the present disclosure for improving user control of a handheld device comprises a body configured to conform to a digit; and a member connected to the body adjacent to a distal portion of the digit, wherein bringing the member into contact with the handheld device transfers force from the digit to the handheld device, so as to activate a responsive portion of the handheld device thereby causing a desired response on the handheld device. In some embodiments, the desired response produces an output on a display portion of the handheld device. In some embodiments, when the body is conformed to the digit, the body allows a joint of the digit to move about a complete range of motion of the joint.

In some embodiments, the joint comprises a distal inter-phalangeal joint. In some embodiments, the joint comprises a proximal inter-phalangeal joint. In some embodiments, the joint comprises a metacarpo-phalangeal joint.

In some embodiments, when the body is conformed to the digit, the body allows the distal inter-phalangeal joint to move about its complete range of motion. In some embodiments, when the body is conformed to the digit, the body allows the proximal inter-phalangeal joint to move about its complete range of motion. In some embodiments, when the body is conformed to the digit, the body allows the metacarpo-phalangeal joint to move about its complete range of motion.

In some embodiments, the body can be configured to conform to an entire digit.

In some embodiments, the body can be configured to conform to a portion of a digit. In an embodiment, the portion of the digit comprises a distance between a tip of the digit and the distal inter-phalangeal joint. In an embodiment, the portion of the digit comprises a skin surface surrounding a distal phalanx. In an embodiment, the portion of the digit comprises a distance between a tip of the digit and the proximal inter-phalangeal joint. In an embodiment, the portion of the digit comprises a skin surface surrounding the distal phalanx and a middle phalanx. In an embodiment, the portion of the digit comprises a distance between a tip of the digit and a proximal phalanx. In an embodiment, the portion of the digit comprises a skin surface surrounding the distal phalanx, the middle phalanx, and the proximal phalanx.

In some embodiments, the body can be configured to conform to a portion of the digit comprising a distal phalanx. In some embodiments, the body can be configured to conform to a portion of the digit comprising a middle phalanx. In some embodiments, the body can be configured to conform to a portion of the digit comprising a proximal phalanx. In at least one embodiment, the body can be configured to conform to a portion of the digit comprising the distal phalanx, the middle phalanx, the proximal phalanx, or combinations thereof. In at least one embodiment, the body can be configured to conform to the distal phalanx, the middle phalanx, the proximal phalanx, or combinations thereof, so that when the body is conformed to the digit, the body allows the distal inter-phalangeal joint, the proximal inter-phalangeal joint, and the metacarpo-phalangeal joint to each move about its complete range of motion.

In an embodiment, an apparatus of the present disclosure is provided for improving ergonomics of a handheld device. In an embodiment, an apparatus for improving ergonomics of a handheld device increases access to the handheld device for a user having a physical limitation associated with a hand. In an embodiment, an apparatus for improving ergonomics of a handheld device improves a user's motor control over the handheld device. In an embodiment, an apparatus for improving ergonomics of a handheld device improves a user having a physical limitation associated with a hand's motor control over the handheld device. In some embodiments, the apparatus for improving ergonomics of a handheld device comprises a body configured to conform to a digit, and a force transferring member connected to the body adjacent to a distal portion of the digit.

In some embodiments, the apparatus for improving ergonomics of a handheld device comprises a body configured to conform to a digit, wherein when the body is conformed to the digit, the body allows the digit to move a maximum range of motion through a joint of the digit, and a force transferring member connected to the body, and positioned adjacent to a distal portion of the digit, wherein the positioning of the member adjacent to the distal portion of the digit allows a the digit to remain substantially parallel to a face of the handheld device when the member transfers force from the digit to the responsive portion of the handheld device. In some embodiments, the positioning of the member adjacent to the distal portion of the digit allows a longitudinal axis of the digit to remain substantially parallel to a planar surface of the handheld device when the member transfers force from the digit to the responsive portion of the handheld device. In some embodiments, the positioning of the member adjacent to the distal portion of the digit allows the distal portion of the digit to remain in substantial alignment with a middle portion of the digit when the member transfers force from the digit to the responsive portion of the handheld device. In some embodiments, the positioning of the member adjacent to the distal portion of the digit allows the distal portion of the digit to remain in substantial alignment with a middle portion of the digit and a proximal portion of the digit when the member transfers force from the digit to the responsive portion of the handheld device.

In at least one embodiment, when the member transfers force from a digit to a responsive portion of a handheld device, the member transforms an unnatural digit movement into a natural digit movement.

In an embodiment, an apparatus of the present disclosure is provided for reducing an effective surface area of a tip of the digit. In an embodiment, an apparatus of the present disclosure for reducing an effective surface area of a tip of the digit comprises a body designed to conform to a tip of the digit; and a member situated on the body adjacent to the tip of the digit, wherein the member has a contact surface area less than about half a surface area of an average size tip of the digit so as to reduce the effective surface area of the tip of the digit. In some embodiments, the member has a contact surface area less than about a surface area of a tip of the digit of a user so as to reduce an effective surface area of a tip of the digit.

In an embodiment, an apparatus of the present disclosure is provided for reducing a likelihood of receiving an injury to a digit while using a handheld device. In an embodiment, an apparatus of the present disclosure for reducing a likelihood of receiving an injury to a digit while using a handheld device comprises a body configured to receive the digit; and a member situated on the body adjacent to a distal portion of the digit, wherein contact between the member and the handheld device transfers a first force from the digit to the handheld device while minimizing the impact of a second force transferred from the handheld device to the digit.

An apparatus of the present disclosure can be used to improve user control of a handheld device. In an embodiment, the apparatus of the present disclosure can be used to improve user control of the handheld device by improving the speed of using the handheld device. In an embodiment, the apparatus of the present disclosure can be used to improve user control of a handheld device by improving the accuracy of using the handheld device. In an embodiment, the apparatus of the present disclosure can save the user time and frustration by improving user control of the handheld device. In an embodiment, the apparatus of the present disclosure can improve user control of a handheld device by reducing digit slippage while using the handheld device. In an embodiment, the apparatus of the present disclosure can improve user control of a handheld device by reducing error rates while using the handheld device. In embodiments, the apparatus of the present disclosure can improve user control of a handheld device by increasing the frequency of activating only target responsive portions of the handheld device rather than activating adjacent non-target responsive portions of the handheld device. In an embodiment, the apparatus of the present disclosure can improve user control of a handheld device by increasing the frequency in which the user of the handheld device activates only a single responsive portion of the handheld device each time the user touches the handheld device rather than activating multiple responsive portions of the handheld device at the same time.

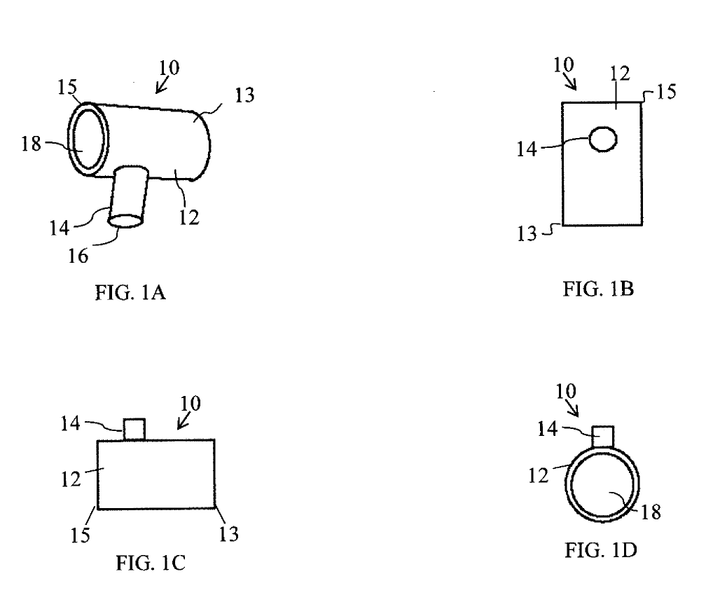

FIGS. 1A, 1B, 1C, and 1D show an apparatus 10 that includes a body 12 configured to conform to a digit (not shown), and a member 14, connected to the body 12, for transferring force from a digit to a handheld device (not shown). Body 12 has an opening 18 extending longitudinally through a central void of the body 12 from the proximal end 13 (FIG. 1D) to the distal end 15 (FIG. 1A). As explained in detail below, placing a digit through the opening 18 allows the body 12 to conform to the digit so that the member 14 can be positioned adjacent to the digit between the digit and the handheld device. In an embodiment, the member 14 is positioned adjacent to a distal portion of the digit between the digit and the handheld device. In an embodiment, the member 14 is positioned adjacent to a tip of the digit between the digit and the handheld device. In an embodiment, the member 14 is positioned adjacent to a middle portion of the digit between the digit and the handheld device. Positioning the member 14 adjacent to the digit between the digit and the handheld device allows a user of the apparatus 10 to bring the member 14 into contact with the handheld device by movement of the digit toward the handheld device. In such a position, repeating digit movements allows member 14 to make repetitive contact with the handheld device. Without wishing to be bound by theory, it is believed that bringing the member 14 into contact with the handheld device transfers force from the digit to the handheld device as if the digit itself were touching the handheld device. It is believed that any transfer of force that can be performed with the digit itself on the handheld device can be replicated by using the member 14 to perform an action on the handheld device. This way, apparatus 10 can be used to transfer force from the digit to the handheld device to activate a responsive portion of the handheld device as if the digit itself were being used to activate the responsive portion of the handheld device. In other words, apparatus 10 functions as an extension of a tip of the digit that, like an ordinary tip of the digit, can be used to manipulate a handheld device to improve user control over the handheld device. In some embodiments, activation of the responsive portion of the handheld device causes a desired response on the handheld device. In some embodiments, the desired response produces an output on a display portion of the handheld device.

The body 12 includes an opening 18 extending between the proximal end 13 and the distal end 15, the opening 18 being configured to receive a digit to allow the body 12 to conform to the digit. It should be appreciated that by conforming to the digit, the body 12 stably fixes itself adjacent to the body so that when the member 14 is connected to the body, the member 14 can be positioned in a substantially fixed position adjacent to the digit. In this regard, the body 12 functions as a place holder to hold the member 14 in place adjacent to a desired portion of a digit surface. It is believed that the body 12 can accomplish this function when the body is minimally conformed to the digit. In an embodiment, the body 12 can be minimally conformed to the digit by configuring the body 12 to have a first surface in physical contact with a first portion of a digit and a second surface integral to the first surface, the second surface being in physical contact with a second opposite portion of the digit. In other words, the body is capable of conforming to the digit if the body 12 is configured to have at least two opposing surfaces integrally connected to each other wherein each of the opposing surfaces are in physical contact with a digit.

In some embodiments, the body 12 can be configured to minimally conform to a digit. In such embodiments, the body 12 can be designed to be discontinuous circumferentially about the digit. In some embodiments, the body 12 can be configured to maximally conform to a digit. In such embodiments, the body 12 can be designed to be continuous circumferentially about the digit.

In an embodiment, the body 12, can be configured with an opening 18 sized large enough for the opening to receive the digit, yet small enough for the body to be snug on the digit as the body 12 conforms to the digit. To prepare apparatus 10 for use, the opening 18 receives a digit into the proximal end 13 of the body 12 and the digit may, in some embodiments, extend beyond the distal end 15 of the body 12 so that the digit substantially occupies the entire space in the opening 18 as the body 12 conforms to the digit. By conforming to the digit, body 12 holds the member 14 in a substantially fixed position adjacent to a distal portion of the digit between the digit and a handheld device. It is believed that fixing the member 14 in position adjacent to the distal portion of the digit allows the user of the apparatus 10 to have improved control over movement of the member 14. That way, the apparatus 10 can be used to manipulate a handheld device with precision by moving the digit towards a target responsive portion of the handheld device to activate the target responsive portion of the handheld device. In other words, apparatus 10 can be used to interact with a user interface of a handheld device so that contact by surface 16 of member 14 of apparatus 10 with an input portion of the user interface results in a change in output that is displayed or otherwise visibly noticeable on the handheld device. In an embodiment, activation of the responsive portion of the handheld device causes a desired response on the handheld device. In some embodiments, the desired response produces an output on a display portion of the handheld device.

In some embodiments, the body 12 can be configured to conform to an entire digit. In some embodiments, when the body is conformed to the entire digit, a tip of the digit portion is exposed. In some embodiments, when the body is conformed to the entire digit, a tip of the digit portion is covered. In some embodiments, when the body is conformed to the entire digit, substantially the entire digit occupies the opening between the proximal end 13 and the distal end 15 of the body.

In some embodiments, the body can be configured to conform to a portion of the digit. In an embodiment, the portion of the digit comprises a distance between a tip of the digit and the distal inter-phalangeal joint. In an embodiment, the portion of the digit comprises a skin surface surrounding a distal phalanx. In an embodiment, the portion of the digit comprises a distance between a tip of the digit and the proximal inter-phalangeal joint. In an embodiment, the portion of the digit comprises a skin surface surrounding the distal phalanx and a middle phalanx. In an embodiment, the portion of the digit comprises a distance between a tip of the digit and a proximal phalanx. In an embodiment, the portion of the digit comprises a skin surface surrounding the distal phalanx, the middle phalanx, and the proximal phalanx.

In some embodiments, the body can be configured to conform to a portion of the digit comprising a distal phalanx, so that the distal phalanx substantially occupies the opening 18 from the proximal end 13 to the distal end 15 of the body. In some embodiments, the body can be configured to conform to a portion of the digit comprising a middle phalanx, so that the middle phalanx substantially occupies the opening 18 from the proximal end 13 to the distal end 15 of the body. In some embodiments, the body can be configured to conform to a portion of the digit comprising a proximal phalanx, so that the proximal phalanx substantially occupies the opening 18 from the proximal end 13 to the distal end 15 of the body. In at least one embodiment, the body can be configured to conform to a portion of the digit comprising the distal phalanx, the middle phalanx, the proximal phalanx, and portions or combinations thereof. In at least one embodiment, the body can be configured to conform to the distal phalanx, the middle phalanx, the proximal phalanx, and portions or combinations thereof, so that when the body is conformed to the digit, the body allows the distal inter-phalangeal joint, the proximal inter-phalangeal joint, and the metacarpo-phalangeal joint to each move about its complete range of motion.

In some embodiments, when the body is conformed to the digit, the body allows a joint of the digit to move about a complete range of motion of the joint. It should be appreciated that when the body is conformed to the digit, the body permits the joint to move about its complete range of motion whether the body conforms to the digit covering the joint, whether the body conforms to the digit adjacent to the joint, or whether the body conforms to the digit and does not cover the joint. In some embodiments, the joint comprises a distal inter-phalangeal joint. In some embodiments, the joint comprises a proximal inter-phalangeal joint. In some embodiments, the joint comprises a metacarpo-phalangeal joint. In some embodiments, when the body is conformed to the digit, the body allows the distal inter-phalangeal joint to move about its complete range of motion. In some embodiments, when the body is conformed to the digit, the body allows the proximal inter-phalangeal joint to move about its complete range of motion. In some embodiments, when the body is conformed to the digit, the body allows the metacarpo-phalangeal joint to move about its complete range of motion. In at least one embodiment, when the body is conformed to the entire digit, the body allows the distal inter-phalangeal joint, the proximal inter-phalangeal joint, and the metacarpo-phalangeal joint to each move about their complete range of motion.

It should be appreciated that, because contact surface 16 of member 14 can be designed to have a surface area about the same or less than the surface area of the responsive portion of a handheld device, a user of the apparatus 10 can activate a target responsive portion of the handheld device with decreased chances of activating an adjacent non-target responsive portion of the handheld device. As such, apparatus 10 of the present disclosure can be used to improve accuracy and user control of a handheld device.

In some embodiments, opening 18 can be configured to receive a thumb to allow the body 12 to conform to the thumb for subsequent use of the apparatus 10 for improved user control of a handheld device. In some embodiments, opening 18 can be configured to receive a pointer digit to allow the body 12 to conform to the pointer digit for use of the apparatus 10 for improved user control of a handheld device. In some embodiments, opening 18 can be configured to receive a middle digit to allow the body 12 to conform to the middle digit for use of the apparatus 10 for improved user control of a handheld device. In some embodiments, opening 18 can be configured to receive an index digit to allow the body 12 to conform to the index digit for use of the apparatus 10 for improved user control of a handheld device. In an embodiment, opening 18 can be configured to receive a ring digit to allow the body 12 to conform to the ring digit for use of the apparatus 10 for improved user control of a handheld device. In an embodiment, opening 18 can be configured to receive a pinky digit to allow the body 12 to conform to the pinky digit for use of the apparatus 10 for improved user control of a handheld device.

In certain embodiments, opening 18 can be configured to receive an artificial digit or thumb. In one embodiment, the artificial digit or thumb comprises a prosthetic digit or thumb. In an embodiment, the artificial digit or thumb comprises a bionic digit or thumb. In an embodiment, the artificial digit or thumb comprises a mechanical digit or thumb.

In general, opening 18 can be provided with any cross-sectional area suitable for accommodating a digit. The cross-sectional area of the opening 18 can be designed to accommodate a specific digit based on a range of average size digits. The cross-sectional area of the opening 18 can be designed to accommodate a specific digit of a particular user. The cross-sectional area of the opening 18 can be designed to accommodate a specific digit based on a range of atypical size digits. In some embodiments, the cross-sectional area of the opening 18 can be designed to accommodate an average small size digit. In some embodiments, the cross-sectional area of the opening 18 can be designed to accommodate an average medium size digit. In some embodiments, the cross-sectional area of the opening 18 can be designed to accommodate an average large size digit. In some embodiments, the cross-sectional area of the opening 18 can be designed to accommodate a below average small size digit. In some embodiments, the cross-sectional area of the opening 18 can be designed to accommodate an above average small size digit. In some embodiments, the cross-sectional area of the opening 18 can be designed to accommodate a below average medium size digit. In some embodiments, the cross-sectional area of the opening 18 can be designed to accommodate an above average medium size digit. In some embodiments, the cross-sectional area of the opening 18 can be designed to accommodate a below average large size digit. In some embodiments, the cross-sectional area of the opening 18 can be designed to accommodate an above average large size digit. In some embodiments, the cross-sectional area of the opening 18 can be designed to accommodate an average extra small size digit. In some embodiments, the cross-sectional area of the opening 18 can be designed to accommodate an average extra large size digit.

In some embodiments, opening 18 can be provided with a first area at the proximal end 13 of the body 12 and a second area at the distal end 15 of the body 12. By designing opening 18 with a first area at the proximal end 13 and a second area at the distal end 15, opening 18 can be tailored to conform to the contours of a digit so that the body 12 better conforms to the digit. In one embodiment, the first area at the proximal end can be larger than the second area at the distal end so that body 12 becomes longitudinally tapered along the length of the opening 18 from the proximal end 13 to the distal end 15 of the body 12. In embodiments, opening 18 can have a first area at the proximal end 13, a second area at the distal end 15, and a third area at any distance along the longitudinal length of the opening 18 between the proximal 13 and distal 15 ends of the body. By providing the opening with a third area in a central location along the length of the body between the proximal and distal ends, body 12 can be customized to fit unusual digit or thumb types, such as for example, a user having larger than normal knuckles.

In some embodiments, the opening 18 comprises a void extending from the proximal end 13 to the distal end 15 of the body 12. In such embodiments, the void has a volume of about the volume of a digit to be received in the opening 18. In various embodiments, the void has a volume of about the volume of an average small size digit, an average medium size digit, an average large size digit, a below average small size digit, an above average small size digit, a below average medium size digit, an above average medium size digit, a below average large size digit, an above average large size digit, an average extra small size digit, or an average extra large size digit.

It should be appreciated that the body 12 can be formed having any shape or dimensions sufficient to allow the opening 18 to receive a digit so that the body 12 can conform to the digit (e.g., thumb, pointer, middle, index, pinky). In an embodiment, body 12 has a tubular shape. In an embodiment, body 12 has a cylindrical shape. In an embodiment, body 12 has a rectangular shape. In an embodiment, the body 12 has an irregular shape. In an embodiment, the body 12 has a symmetrical shape. In an embodiment, the body 12 has an asymmetrical shape. In embodiments, the body 12 can be formed having a custom shape suitable to conform to a particular type of digit (e.g., thumb, pointer, middle, index, pinky).

The body 12 can be formed using any material capable of allowing the body 12 to conform to a digit (e.g., thumb, pointer, middle, index, pinky). Examples of suitable materials include, but are not limited to a moisture resistant material, a soft-impact material, an insulative material, a non-conductive material, a non-metallic material, a non-magnetic material, a dull material, an inert material, an organic material, an inorganic material, a moldable material, a flexible material, a rigid material, a resilient material, an elastic material, a metallic material, a magnetic material, a wooden material, a ceramic material, or combinations and equivalents thereof.

In some embodiments, the thickness of the body 12 can be custom designed as desired. In some embodiments, the longitudinal length of the body 12 from the proximal end 13 to the distal end 15 can be custom designed depending on the digit length of the particular user. In such embodiments, the body 12 length allows the body 12 to conform to and cover substantially the entire length of the digit. In other such embodiments, the body 12 length allows the body 12 to conform to and cover only a portion of the entire length of the digit. In some embodiments, the thickness of the body 12 can be custom designed depending on a comfort level of the particular user. In such embodiments, a body 12 having a large thickness can be provided for use in colder climates. In such embodiments, a body 12 having a small thickness can be provided for use in warmer climates.

In some embodiments, the cross-sectional area of the body 12 can be custom designed depending on the cross-sectional area of the digit of the particular user. In such embodiments, the body 12 can be formed with a predetermined cross-sectional area. For example, a variety of bodies 12 having a range of cross-sectional diameters can be provided to accommodate a range of average size digits as described above.

Although FIGS. 1A, 1B, 1C, and 1D show the apparatus 10 of the present disclosure having body 12 that continuously conforms circumferentially about a digit from the proximal end 13 to a distal end 15 of the body 12, the body 12 can be designed to conform circumferentially discontinuous about a digit from the proximal end 13 to the distal end 15 of the body 12 (not shown). In some embodiments, the body 12 can be discontinuous circumferentially about a digit. In such embodiments, the body 12 can be discontinuous circumferentially about the digit at a portion of the body or along the entire longitudinal length of the body 12 from the proximal end 13 to the distal end of the body 15, provided that the body 12 is capable of conforming to the digit. For example, the body may appear to have a horseshoe-like configuration when viewed from either the proximal end 13 or the distal end 15 of the body. In some embodiments, the body 12 can be discontinuous longitudinally along a digit. In such embodiments, the body 12 can be discontinuous longitudinally along a portion of the body from the proximal end 13 to the distal end 15 of the body. In some embodiments, the body 12 can be discontinuous both longitudinally along the length of the digit and circumferentially about the digit so that only portions of the body 12 conform to the digit, so long as the body 12 can conform to the digit and a member 14 can be situated on the body 12 in a way that allows the member 14 to transfer force from the digit to a handheld device.

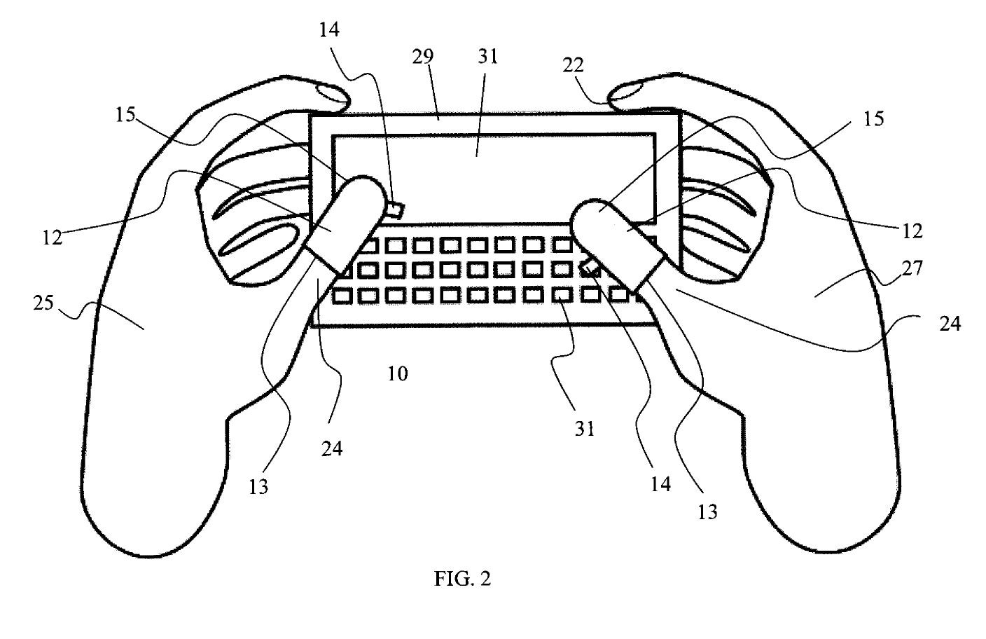

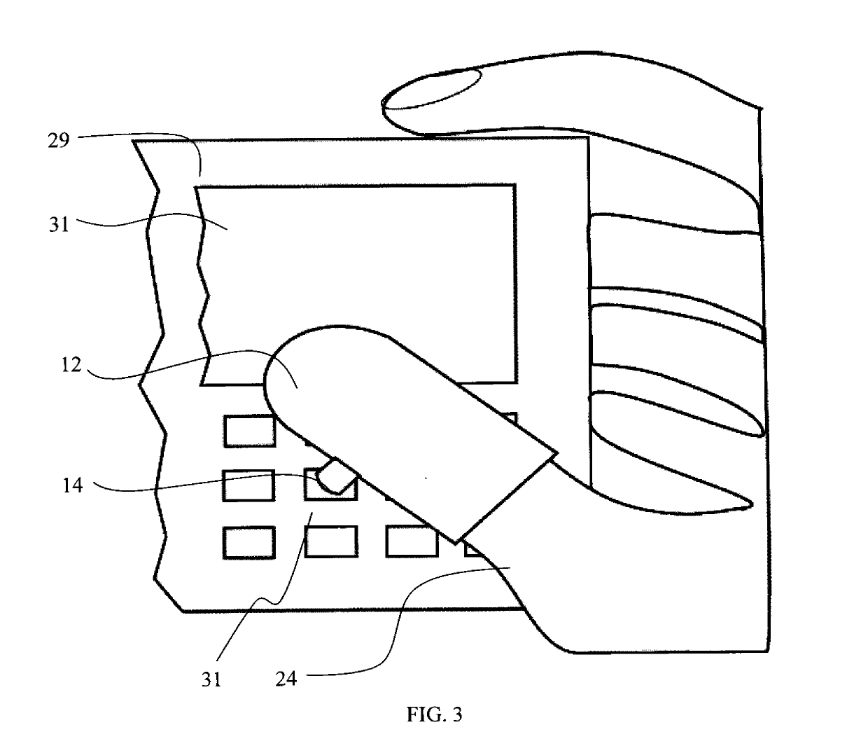

FIG. 2 shows the apparatus 10 of the present disclosure being used to control a handheld device 29. FIG. 3 shows a close-up partial perspective view of the apparatus 10 shown in FIG. 2 highlighting the member 14 being used to contact a responsive portion 31 of the handheld device 29. As shown in FIG. 2 and FIG. 3, the apparatus includes a body 12 configured to conform to a digit 24, and a member 14 for transferring force from the digit 24 to the handheld device 29, so as to activate a responsive portion 31 of the handheld device 29 thereby causing a desired response on the handheld device. In an embodiment, the desired response comprises an output on a display portion of the handheld device. Illustrative of the various modes of operation of apparatus 10, FIG. 2 shows that a plurality of apparatuses 10 can be used at about the same time to improve user control of a handheld device. In some embodiments, one or more apparatuses 10 can be used at about the same time on one hand (not shown). In other embodiments, as illustrated in FIG. 2, one or more apparatuses 10 can be used at about the same time on each hand.

The member 14 can generally be used to transfer force from a digit to multiple responsive portions of a handheld device, as well as multiple types of responsive portions of a handheld device. In one embodiment, as shown in FIG. 2 and FIG. 3, a body 12 as conformed to thumb 24 of right hand 27 is being used to position member 14 between the thumb 24 and the handheld device 29. In this instance, the member 24 is shown transferring force from the thumb 24 to a first responsive portion 31 of the handheld device 29 to activate a key (e.g., button) of the handheld device. In another embodiment shown in FIG. 2, a body 12 as conformed to thumb 24 of left hand 25 is being used to position member 14 between the thumb 24 and the handheld device 29. In this instance, the member 24 is shown transferring force from the thumb 24 to a second responsive portion 31 of the handheld device 29 to activate a touchscreen of the handheld device.

In some embodiments, the member 14 is connected to the body 12 adjacent to a distal portion of the digit 24 between the digit 24 and the handheld device 31 so that subsequent movement of the digit 24 towards the handheld device 29 brings the member 14 into contact with the responsive portion 31 of the handheld device 29. While not wishing to be bound by theory, it is believed that bringing the member 14 into contact with the responsive portion 31 of the handheld device 29 transfers force from the digit 24 to the handheld device 29 thereby activating the responsive portion 31 of the handheld device. In some embodiments, the member 14 is positioned adjacent to a tip of the digit 22 between a tip of the digit 22 and the handheld device 29. In an embodiment, the member 14 can be positioned adjacent to a volar surface of a digit tip between the volar surface of the tip of the digit and the handheld device 29. In an embodiment, the member 14 can be positioned adjacent to the digit between the digit and a responsive portion 31 of a handheld device 29. In an embodiment, the member 14 can be configured to be positioned adjacent to a tip of the digit between the tip of the digit and the responsive portion of a handheld device. In an embodiment, the member 14 can be configured to be positioned between the volar surface of a tip of the digit and the responsive portion of a handheld device.

Those of skill in the art will appreciate that the responsive portion of the handheld device varies between device types, manufacturers, models, or the like. By way of illustration, and not of limitation, for example, the responsive portion of a handheld device, such as a smartphone, having a qwerty keyboard includes any buttons or keys of the qwerty keyboard itself, however, the responsive portion may also include a trackball, a scroll wheel, or a switch. For a handheld device having a touchscreen, the responsive portion may include any portion of the touchscreen that performs an action on the handheld device in response to touching that particular portion, including a virtual key from an onscreen virtual qwerty keyboard. Touchscreen-enabled devices can provide a robust graphical user interface that allows a user to interact with the device by touching, dragging, and pointing at displayed elements on a touchscreen. Applications can be launched by tapping on an icon from a launch screen. While an application is open, the touchscreen is used to both display output to the user and to accept user input. An example of a mobile device equipped with such a touchscreen is the IPHONE®, available from Apple Inc. of Cupertino, Calif.

The responsive portion 31 of the handheld device 29 can be activated by using the member 14 to perform any action on the handheld device that can be performed without apparatus 10 by mere use of a digit. In some embodiments, the responsive portion of the handheld device can be activated by using the member to perform a gesture on the handheld device. In an embodiment, the gesture is a tap. In an embodiment, the gesture is a swipe. In an embodiment, the gesture is a drag. In an embodiment, the gesture is a flick. In an embodiment, the gesture is a pinch. In one embodiment, the gesture includes a tap, a swipe, a drag, a flick, a pinch, and equivalents or combinations thereof. In some embodiments, the member 14 can be used to perform a gesture on the handheld device. In certain embodiments, performing a gesture on the handheld device triggers a user intended response of the handheld device.

In some embodiments, the responsive portion of the handheld device can be activated by using the member 14 for typing with the handheld device. In some embodiments, the responsive portion of the handheld device can be activated by using the member 14 for tapping the handheld device. In some embodiments, the responsive portion of the handheld device can be activated by using the member 14 for pressing the handheld device. In such embodiments, the member 14 is used to press the responsive portion of the handheld device. In some embodiments, the responsive portion of the handheld device can be activated by using the member 14 for writing on the handheld device. In such embodiments, the member 14 can be used to write cursively with the handheld device. In such embodiments, the member 14 can be used to write in print with the handheld device. In such embodiments, the member 14 can be used to write in short hand with the handheld device. In some embodiments, the member 14 can be used to enter alphanumeric codes or characters. In some embodiments, the responsive portion of the handheld device can be activated by using the member 14 for drawing with the handheld device. In some embodiments, the responsive portion of the handheld device can be activated by using the member 14 for painting or drawing with the handheld device. In some embodiments, the responsive portion of the handheld device can be activated by using the member 14 for switching a portion of the handheld device. In some embodiments, the responsive portion of the handheld device can be activated by using the member 14 for sliding the responsive portion of the handheld device.

In some embodiments, the responsive portion of the handheld device can be activated by using the member 14 for texting with the handheld device. In such embodiments, the member 14 can be used for message texting. In such embodiments, the member 14 can be used for picture texting. In such embodiments, the member 14 can be used for video texting.

In some embodiments, the responsive portion of the handheld device can be activated by using the member 14 for selecting with the handheld device. In some embodiments, the responsive portion of the handheld device can be activated by using the member 14 for inputting with the handheld device. In some embodiments, the responsive portion of the handheld device can be activated by using the member 14 for holding the responsive portion of handheld device in a particular position or for a predetermined time period.

In at least one embodiment, the responsive portion of the handheld device can be activated by using the member to perform on the handheld device an action including one of a gesture, typing, tapping, pressing, writing, drawing, painting, switching, sliding, texting, selecting, inputting, holding, or combinations and equivalents thereof.

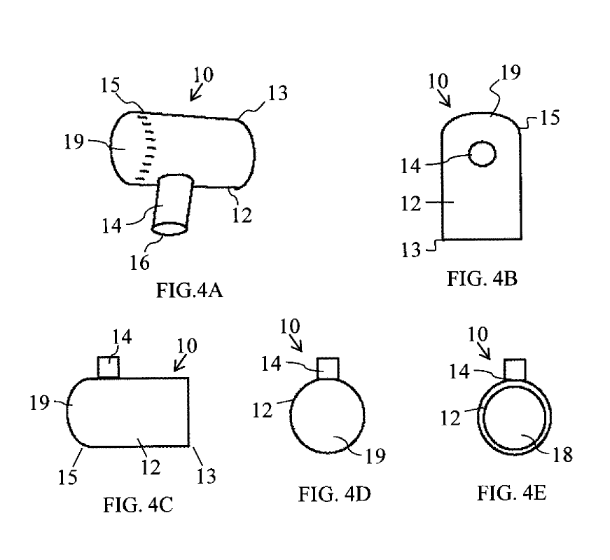

FIGS. 4A, 4B, 4C, 4D, and 4E show another embodiment of apparatus 10. As shown in FIGS. 4A-4D, the body 12 can be provided with a covering 19 at the distal end 15 of the body 12 to minimize displacement of the body from its position as conformed to the digit. Covering 19 is designed so that when a user places a digit through opening 18 (shown in FIG. 4E), the digit extends longitudinally through the center of the body 12 until it reaches covering 19 so that the covering 19 is adjacent to a tip of the digit of the user. In some embodiment, covering 19 can be used to enhance conforming of the body 12 to the digit. In such embodiments, covering 19 reduces displacement of body 12 from its original position on the digit. Without wishing to be bound by theory, it is believed that minimizing displacement of the body 12 from its original position as conformed to the digit allows the member 14 to remain in a substantially fixed position with respect to the digit. It is believed that maintaining the member 14 in a substantially fixed position with respect to the digit improves accuracy of the apparatus 10. In an embodiment, covering 19 reduces slippage of the body 12 while the apparatus 10 is being used. In such embodiments, reducing slippage of the body 12 reduces slippage of the member 14 as the member 14 makes contact with the handheld device, thereby improving accuracy of the apparatus 10. In such embodiments, reducing slippage of the body 12 reduces slippage of the member 14 as the member 14 transfers force from the digit to the handheld device, thereby improving accuracy of the apparatus 10. In an embodiment, covering 19 can prevent slippage of the body 12 while the apparatus 10 is being used to improve accuracy of the apparatus.

Generally, the body 12 holds the member 14 in place on the body adjacent to a distal portion of a digit between the proximal end 13 and the distal end 15 of the body. In some embodiments, the member 14 can be situated on the covering 19 so that the member 14 is adjacent to the tip of the digit portion of the digit. In such embodiments, the member 14 can be provided in addition to the member 14 situated on the body 12 between the proximal 13 and distal 15 ends of the body 12. In such embodiments, one or more member 14 can be provided on the covering 19 in addition to one or more members 14 situated on the body between the proximal 13 and distal 15 ends of the body. In certain embodiments, the member 14 can be provided exclusively on the covering 19. In such embodiments, no member is situated on the body 12 between the proximal end 13 and the distal end 15 of the body except for on the covering 19 at the distal end 15.

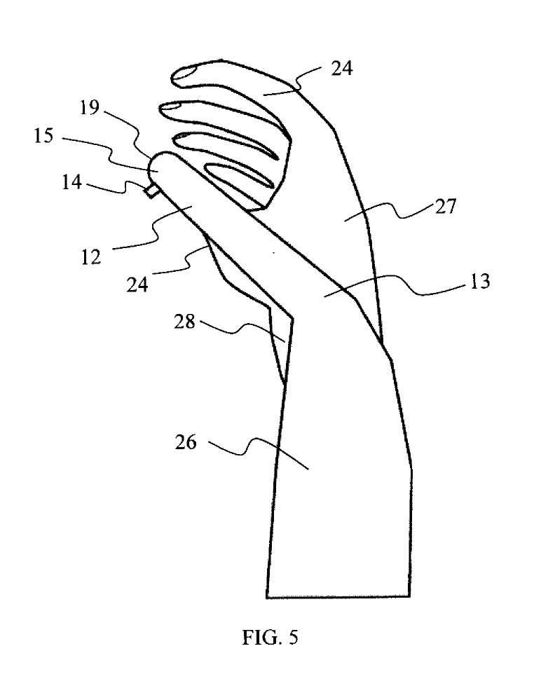

FIG. 5 shows another embodiment of apparatus 10. It should be appreciated that the embodiment as shown in FIG. 5 works in substantially the same manner as described elsewhere herein. As shown in FIG. 5, apparatus 10 includes a body 12 configured to conform to a digit 24, a member 14 connected to the body 12 adjacent to a distal portion of the digit 24 for transferring force from the digit to a handheld device (not shown), and a sleeve (or other article of clothing or clothing accessory) 26 connected to the proximal end 13 of the body 12 for helping the body 12 conform to the digit 24. In FIG. 5, body 12 is shown as extending from sleeve (or other article of clothing or clothing accessory) 26 and is shown as being integrated with the body 12 so that sleeve (or other article of clothing or clothing accessory) 26 and body 12 form a single element, however, sleeve (or other article of clothing or clothing accessory) 26 may be a distinct and separate element from the body 12. In the latter case, sleeve (or other article of clothing or clothing accessory) 26 can be connected to the body 26 by any suitable means (e.g., adhesive, sewn, fastened, clipped, etc. . . . ). Without wishing to be bound by theory, it is believed that sleeve (or other article of clothing or clothing accessory) 26 increases the tension between the distal end 15 and the proximal end 13 of the body 12 so that the body 12 can better conform to the digit 24. It is believed that as the body 12 conforms better to the digit 24, the accuracy of the apparatus 10 increases. Increasing the accuracy of apparatus 10 this way allows a user of the apparatus 10 to increase the frequency with which the user activates an intended responsive portion of a handheld device rather than an unintended responsive portion of the handheld device.

The body 12 can be configured to conform to any digit on any hand. FIG. 5 shows the body 12 configured to conform to a thumb 24 on a right hand 27, however, it should be appreciated that the body 12 can be configured to conform to a thumb 24 on a left hand (not shown).

In some embodiments, the body 12 can be configured to conform to a digit on the right hand. In such embodiments, the body 12 can be configured to conform to a pinky digit. In such embodiments, the body 12 can be configured to conform to a ring digit. In such embodiments, the body 12 can be configured to conform to a middle digit. In such embodiments, the body 12 can be configured to conform to a pointer digit. In such embodiments, the body 12 can be configured to conform to a thumb.

In other embodiments, the body 12 can be configured to conform to a digit on the left hand. In such embodiments, the body 12 can be configured to conform to a pinky digit. In such embodiments, the body 12 can be configured to conform to a ring digit. In such embodiments, the body 12 can be configured to conform to a middle digit. In such embodiments, the body 12 can be configured to conform to a pointer digit. In such embodiments, the body 12 can be configured to conform to a thumb.

Although FIG. 5 shows covering 19 at distal end 15 of the body 12, it should be appreciated that the body 12 can also be designed so that opening 18 extends to the distal end 15 to leave the tip of the digit exposed such as those embodiments shown in FIGS. 1A-1D, FIGS. 6A-6D, FIG. 7, FIGS. 9A and 9B, and FIGS. 10A and 10B.

While FIG. 5 shows only one body 12 integrally connected to sleeve (or other article of clothing or clothing accessory) 26, it should be appreciated that one body 12 can be connected to sleeve (or other article of clothing or clothing accessory) 26 for each digit 24. In an embodiment, sleeve (or other article of clothing or clothing accessory) 26 is connected to one body 12 configured to conform to one digit 24. In an embodiment, sleeve (or other article of clothing or clothing accessory) 26 is connected to two bodies 12, each body 12 being configured to conform to a different digit 24. In an embodiment, sleeve (or other article of clothing or clothing accessory) 26 is connected to three bodies 12, each body 12 being configured to conform to a different digit 24. In an embodiment, sleeve (or other article of clothing or clothing accessory) 26 is connected to four bodies 12, each body 12 being configured to conform to a different digit 24. In an embodiment, sleeve (or other article of clothing or clothing accessory) 26 is connected to five bodies 12, each body 12 being configured to conform to a different digit 24. In an embodiment, the article of clothing 26 is a sleeve that covers a user's arm 28.

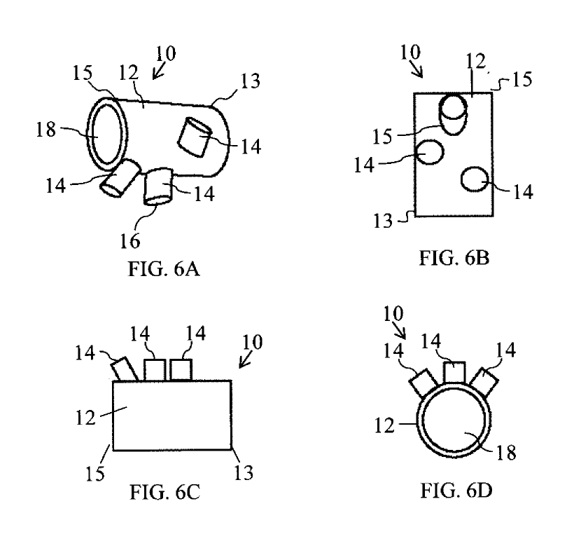

FIGS. 6A, 6B, 6C, and 6D show an embodiment of the apparatus 10 of the present disclosure in which the body 12 includes a plurality of members 14 situated on the body 12. In an embodiment, one or more additional members are situated on the body 12 between the proximal end 13 and the distal end 15. Without wishing to be bound by theory, it is believed that providing additional members 14 on the body 12 can improve user control of a handheld device by increasing the speed of using the handheld device. It is believed that increasing the number of members 14 on the body 12 increases the effective number of tip of the digits that can occupy the limited space available for activating the responsive portions of the handheld device. By way of illustration, and not of limitation, the physical space surrounding a particular responsive portion of a smartphone having a qwerty keyboard is limited so that only a single tip of the digit can occupy such space. Actually, a single tip of the digit occupies the space of a plurality of responsive portions of the typical smartphone making it difficult to activate one among the plurality of responsive portions without inadvertently activating adjacent responsive portions. By providing multiple members 14 on the body 12, each member having a cross-sectional contact surface area about the same area as the responsive portions of the qwerty keyboard of the smartphone, apparatus 10 can be used to increase the effective number of tip of the digits occupying the physical space surrounding the plurality of responsive portions. For example, whereas an actual tip of the digit may occupy the entirety of the physical space of about four keys of a qwerty keyboard of a typical smartphone handheld device, providing a body 12 having four members 14 situated on the body adjacent to each other, allows the apparatus to effectively place the equivalent of four tip of the digits in the space previously occupied by a single tip of the digit. This way, each of the responsive portions of the handheld device adjacent to each other among a plurality of adjacent responsive portions of the handheld device can be contacted with precision with a different member 14, without simultaneously contacting an adjacent member 14. By increasing the accuracy of consecutively contacting adjacent responsive portions of a handheld device occupying limited physical space, apparatus 10 provided with a plurality of members 14 can substantially increase the speed of using the handheld device.

In some embodiments, a plurality of members 14 situated on the body 12 have a space between the plurality of members 14 to reduce the likelihood of multiple members activating (e.g., transferring force) a single responsive portion of a handheld device. In some embodiments, the space between the members comprises a distance equivalent to about a distance between adjacent responsive portions of a handheld device. In some embodiments, the space between the members enables each of the plurality of members 14 to activate a different responsive portion of a handheld device. In some embodiments, the space between the members facilitates removal and replacement of adjacent members by making it easier for a user of the apparatus 10 to grasp the members.

In some embodiments, two members are situated on the body 12 between the proximal end 13 and the distal end 15, each member provided for transferring force from the digit to the handheld device to activate a responsive portion of the handheld device. In some embodiments, three members are situated on the body 12 between the proximal end 13 and the distal end 15, each member provided for transferring force from the digit to the handheld device to activate a responsive portion of the handheld device. In some embodiments, up to four members, up to five members, up to six members, up to seven members, up to eight members, up to nine members, up to ten or more members can be situated on the body 12 between the proximal 13 and distal 15 ends. It should be appreciated that each of the plurality of members 14 situated on the body 12 can be used to transfer force from the digit to the handheld device in order to activate a plurality of responsive portions of the handheld device in a near simultaneous manner. In an embodiment, one or more members 14 can transfer force from the digit to the handheld device to activate one or more responsive portions of the handheld device. In an embodiment, the plurality of members 14 can transfer force consecutively from the digit to the handheld device to activate various responsive portions of the handheld device.

As shown in FIGS. 6A, 6B, 6C, and 6D, the plurality of members 14 generally can be situated on the body 12 in any position along the longitudinal length of the body 12 between the proximal end 13 and distal end 15 of the body 12. Although FIGS. 6A-6D show the three members 14 situated at random on the body 12, the plurality of members 14 can be positioned in an array on the body 12.

As illustrated in FIGS. 6A-6D the plurality of members 14 can generally be oriented at any angle with respect to a plane formed along a longitudinal axis of the body 12. In some embodiments, each member 14 can be oriented at the same angle with respect to the plane formed along the longitudinal axis of the body 12. In certain embodiments, each member 14 can be oriented at different angles with respect to the plane formed along the longitudinal axis of the body 12. In other embodiments, some members 14 can be oriented at the same angles while other members 14 can be oriented at different angles with respect to the plane formed along the longitudinal axis of the body 12. In such embodiments, the member can be oriented an angle of up to about 90° (e.g., up to about 0°, up to about 5°, up to about 10°, up to about 15°, up to about 20°, up to about 25°, up to about 30°, up to about 35°, up to about 40°, up to about 45°, up to about 50°, up to about 55°, up to about 60°, up to about 65°, up to about 70°, up to about 75°, up to about 80°, up to about 85°), with respect to the central longitudinal axis of the body 12. It should be appreciated that the general teachings with respect to the angle of orientation of the plurality of members 14 described here may apply equally to other embodiments in which a single member 14 is situated on the body.

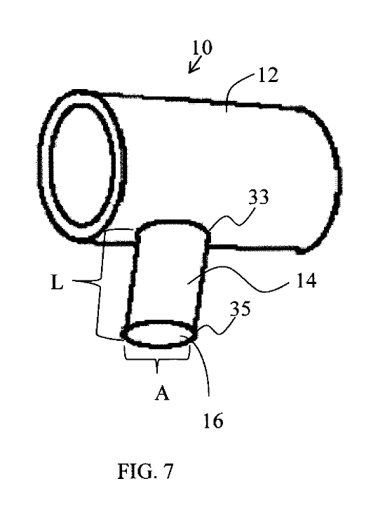

FIG. 7 shows a close-up view of the member 14 of the apparatus 10 of the present disclosure. As shown in FIG. 7, the member 14 is defined by a length L and a cross-sectional area A sufficient to allow the member 14 to transfer force from a digit to a handheld device so that the force transferred is focused onto a responsive portion of the handheld device. In an embodiment, the force transferred is enough to activate the responsive portion of the handheld device. The length of the member L, extends from a proximal end 33 of the member 14 adjacent to the body 12 to a distal end 35 of the member 14 away from the body. In some embodiments, the member 14 is defined by a length L, a cross-sectional area A, and a material composition sufficient to transfer force from a digit to a handheld device. It should be appreciated that the dimensions L and A can modified as desired as the member 14 is not intended to be limited in this manner, so long as the member is capable of transferring force from the digit to the responsive portion of the handheld device. In an embodiment, the minimum value of dimension L is 1 mm. In an embodiment, the minimum value of A is 1 square mm.

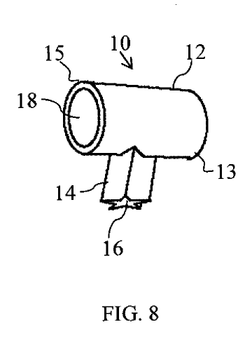

FIG. 8 shows an embodiment of apparatus 10 in which the cross-sectional shape of the member 14 comprises a star. However, the member 14 can be provided with any cross-sectional shape sufficient to allow the member to transfer force from a digit to a handheld device so that the force transferred is focused onto a responsive portion of the handheld device. In an embodiment, the cross-sectional shape of the member 14 comprises a cylinder. In an embodiment, the cross-sectional shape of the member 14 comprises an irregular shape. In an embodiment, the cross-sectional shape of the member 14 comprises an arcuate shape. In an embodiment, the cross-sectional shape of the member 14 comprises a symmetrical shape. In an embodiment, the cross-sectional shape of the member 14 comprises an asymmetrical shape. In an embodiment, the cross-sectional shape of the member 14 comprises a triangle. In an embodiment, the cross-sectional shape of the member 14 comprises a parabola. In an embodiment, the cross-sectional shape of the member 14 comprises a polygon. In an embodiment, the cross-sectional shape of the member 14 comprises a trapezoid. In an embodiment, the member 14 has a tapered cross-sectional shape. In such embodiments, the member 14 is tapered so that it maximizes an amount of impact force when the member 14 is used to contact a surface, such as a responsive portion of a handheld device. In an embodiment, the cross-sectional shape of the member 14 comprises a cube. In an embodiment, the member 14 has a shape resembling a digit. In an embodiment, the member 14 can be shaped to resemble a tip of the digit. In embodiments, the member 14 can be provided with a custom cross-sectional shape. In such embodiments, the member 14 can be formed having predetermined dimensions as desired by a particular user. In such embodiments, a user of the apparatus 10 can visit an internet website and select a member 14 having a predesigned shape for subsequent purchase. In such embodiments, a user of the apparatus 10 can visit an internet website and design a member 14 having a personalized shape for subsequent purchase.

In at least one embodiment, the member 14 can be provided with a cross-sectional shape including, but not limited to a star, square, rectangle, L-shape, triangle, cylinder, tubular, tapered, arcuate, regular, irregular, symmetrical, asymmetrical, polygonal, trapezoidal, parabolic or spring shaped.

In at least one embodiment, the member 14 can be provided with a longitudinal-sectional shape including, but not limited to a star, square, rectangle, L-shape, triangle, cylinder, tubular, tapered, arcuate, regular, irregular, symmetrical, asymmetrical, polygonal, trapezoidal, parabolic or spring shaped.

The member 14 can be formed having any dimensions that would allow the member 14 to transfer enough force from a digit to a handheld device to perform an action on the handheld device. Without wishing to be bound by theory, it is believed that providing a member with a cross-sectional area that is about the same size as the area of a typical responsive portion of a handheld device will allow the member 14 to improve user control of the handheld device. It is believed that when the area of the member 14 matches the area of the responsive portion of the handheld device, a user of the apparatus has a better chance of activating an intended responsive portion of the handheld device rather than an unintended responsive portion of the handheld device. In some embodiments, the member 14 can be provided with a cross-sectional area that is about the same size as the area of a key on a smartphone. In such embodiments, the member 14 can be provided with a cross-sectional area that is specifically designed to be about the same size as the area of key of a particular brand of handheld device, such as a smartphone. By way of illustration, and not of limitation, a user of a BLACKBERRY® smartphone can order an apparatus 10 having a member 14 preconfigured with a cross-sectional area about the same size as the surface area of the keys on the BLACKBERRY® smartphone. In removable and replaceable embodiments described in detail below, the member 14 can be removed and replaced to increase or decrease the cross-sectional area of the member 14 so that the member 14 has about the same size area as the responsive portion surface area of a particular handheld device.

In other embodiments, the cross-sectional area of a member 14 is narrower than the surface area of a responsive portion of the handheld device. In an embodiment, the cross-sectional area of the member 14 is narrower than the surface area of a button of the handheld device so that when member 14 comes into contact with the button of the handheld device the member 14 can activate the button without touching any adjacent buttons. In an embodiment, the cross-sectional area of the member 14 is narrower than the surface area of a key of the handheld device so that when the member 14 comes into contact with the key of the handheld device, the member 14 can touch the key without touching any adjacent keys. In an embodiment, the cross-sectional area of the member 14 is about one-half a centimeter.

In certain embodiments, the cross-sectional area of the member 14 is larger than the surface area of a responsive portion of the handheld device, but narrower than the area occupied by a perimeter defined by the adjacent responsive portions of the handheld device. It is believed that providing a member 14 with a cross-sectional area larger than the surface area of a responsive portion of the handheld device, but smaller than the area occupied by the space surrounding the responsive portion between the responsive portion and adjacent responsive portions, the apparatus 10 can improve accuracy while using a handheld device by optimizing the likelihood of successfully activating a target responsive portion of a handheld device while minimizing the likelihood of activating an adjacent non-target responsive portion of a handheld device. In some embodiments, the cross-sectional area of the member 14 is about the size of an area including the area of a responsive portion of a handheld device and a space surrounding the responsive portion and adjacent responsive portions, so that when the member 14 contacts the responsive portion to transfer force from the digit to the responsive portion, the member does not inadvertently contact an adjacent responsive portion.

The member 14 can be made from any material capable of transferring force from a digit to the handheld device as force from the digit pushes the member into contact with the handheld device. It should be appreciated that any material that allows the member 14 to focus the transferred force onto the responsive portion of the handheld device can be used to form the member 14. In some embodiments, the member 14 can be made from substantially the same material as the body 12 so that the member 14 and the body 12 have similar properties. In other embodiments, the member 14 can be made from substantially different material as the body 12 so that the member 14 and the body 12 have dissimilar properties. Examples of suitable materials include, but are not limited to a moisture resistant material, a soft-impact material, an insulative material, a non-conductive material, a non-metallic material, a non-magnetic material, a dull material, an inert material, an organic material, an inorganic material, a moldable material, a flexible material, a rigid material, a resilient material, an elastic material, a metallic material, a magnetic material, a wooden material, a ceramic material, or combinations and equivalents thereof. It should be appreciated that multiple materials can be used to form the member 14. It should also be appreciated that the materials can be combined in various ways to form the member 14. In some embodiments, materials used to form the member 14 can be layered upon one another. In some embodiments, materials used to form the member 14 can be intertwined upon one another. In some embodiments, materials used to form the member 14 can provide the member 14 with structural symmetry so that properties are uniform throughout the member 14. In some embodiments, materials used to form the member 14 can provide the member 14 with structural asymmetry, so that properties are not uniform throughout the member 14. In one embodiment, the member 14 includes a spring embedded within the member 14 to increase the force transferred from the digit to the responsive portion of the handheld device. In one embodiment, the member 14 includes a spring embedded within the member 14 to decrease the force needed to activate a responsive portion of a handheld device.

The member 14 includes a surface 16 for directly contacting the responsive portion of the handheld device to activate the responsive portion of the handheld device. It should be appreciated that the surface 16 and the member 14 can be formed having similar materials so that the member 14 and the surface 16 have similar properties. Alternatively, the surface 16 and the member 14 can be formed from different materials so that the member 14 and the surface 16 can have different properties. In some embodiments, the surface 16 can be designed to have a low coefficient of friction. In other embodiments, the surface 16 can be designed to have a high coefficient of friction.

In some embodiments, contact surface 16 can be provided with a different cross-sectional area from that of the member 14. In other embodiments, contact surface 16 can be provided with about the same cross-sectional area as that of the member 14. In certain embodiments, the contact surface 16 has a surface area that is about the same as the area of a responsive portion of a handheld device. In such embodiments, the contact surface 16 has a surface area that is about the same as the surface area of a key on a handheld device. In such embodiments, the contact surface 16 has a surface area that is about the same as the surface area of a button on a handheld device. In such embodiments, the contact surface 16 has a surface area that is about the same as the surface area of a touchkey on a touchscreen of a handheld device. In such embodiments, the contact surface 16 has a surface area about the same size as the surface area of an application icon on a touchscreen of a handheld device. In some embodiments, the contact surface 16 has a surface area of about a half centimeter.

In some embodiments, the surface 16 of member 14 comprises a planar surface having a surface area equal to or less than the surface area of an average size alphanumeric key of an alphanumeric keypad on a cellular phone. In certain embodiments, the planar surface 16 of member 14 is parallel to the digit upon which the body 12 of the apparatus 10 is configured to conform to. In certain embodiments, the planar surface 16 of member 14 is not parallel to the digit upon which the body 12 of the apparatus 10 is configured to conform to. In some embodiments, the surface 16 of member 14 comprises a concave surface. In some embodiments, the surface 16 of member 14 comprises a convex surface. In some embodiments, the surface 16 of member 14 comprises a rimmed surface. In some embodiments, the surface 16 of member 14 comprises a textured surface. In an embodiment, the textured surface comprises a sandpaper-like surface for increasing friction between a responsive portion of a handheld device and the surface 16. It is believed that increased friction can result in reduced slippage and greater accuracy per stroke. In an embodiment, the textured surface comprises an abrasive surface. In some embodiments, the surface 16 of member 14 comprises a finished surface. In an embodiment, the finished surface comprises a smooth surface. In an embodiment, the finished surface comprises a rough surface. In an embodiment, the finished surface comprises a polished surface. In some embodiment, the surface 16 of member 14 comprises an abrasive surface.

In certain embodiments, the surface 16 can be provided with a coating. For example, the surface 16 can be provided with a coating designed to protect the surface of the handheld device. Coating the surface 16 of the member 14 with a protective coating can be particularly useful when the member 14 is being used to transfer force from a digit to a sensitive surface on a handheld device, such as a touchscreen. By providing a protective coating, such as a non-abrasive finish, or a scratch resistant tip, or a felt tip, for example, the protective coating on the surface 16 can minimize damage to the surface of the handheld device. Providing a member having a surface with a protective coating may be advantages for use with handheld devices with touch sensitive responsive portions.

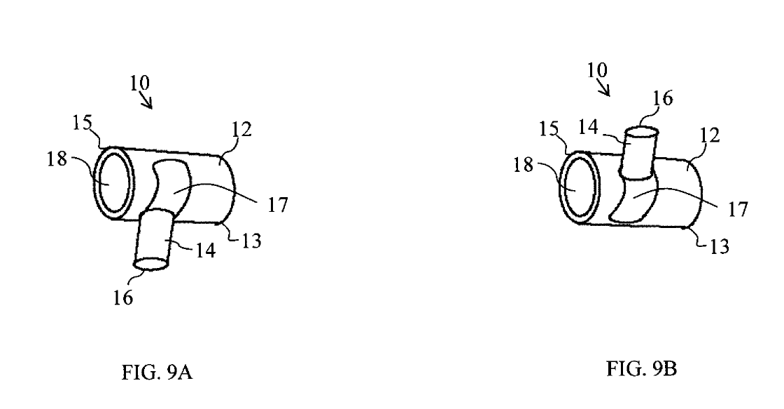

FIGS. 9A and 9B show perspective views of another embodiment of the apparatus 10 of the present disclosure. As shown in FIGS. 9A and 9B, an apparatus 10 of the present disclosure can include a rotatable member 14. FIG. 9A shows the rotatable member 14 positioned in a first position in a track or groove 17 on the body 12. FIG. 9B shows the rotatable member 14 positioned in a second position in the groove 17 on the body 12 shown in FIG. 9A. The groove 17 allows member 14 to be rotated circumferentially about the body 12 so that the user of the apparatus 10 can position the member 14 as desired on the body 12. It should be appreciated that the groove 17 can be located on the body 12 at any distance between the proximal end 13 and the distal end 15 of the body 12. In an embodiment, the member 14 is circumferentially rotatable about a portion of the body from a first position as shown in FIG. 9A to a second position as shown in FIG. 9B. In an embodiment, the member 14 can be rotated a complete 360° about the body beginning at a first position and ending at the first position (not shown). In an embodiment, the member 14 can be rotated continuously circumferentially about the body. In an embodiment, the member 14 can be rotated continuously circumferentially about the body in a single direction. In an embodiment, the member 14 can be rotated continuously circumferentially about the body in a bi-directional manner. In other embodiments, the body 12 can be provided with multiple grooves intersecting with each other to form a gear-shift or joystick like adjustable member 14 (not shown). In such embodiments, the member 14 can be adjusted to allow the user 10 of the apparatus to position the member 14 in a preferred location on the body 12 to enhance the comfort and performance of the apparatus 10.

In other embodiments (not shown), the apparatus 10 of the present disclosure can include a pivotable member 14 that has a central axis of rotation disposed within the body 12 and pivotably moves in any of 360° of rotation and in any direction above the surface of the body 12. The pivotable member 14 can be situated at any position along the longitudinal length of the body 12 from the proximal end 13 to the distal end 15. The pivotable member 14 allows a user of the apparatus 10 to customize the orientation or angle of the member 14 with respect to the planar surface of the body 12 as conformed to the digit. This way, the pivotable member 14 provides a user of the apparatus 10 with total control over the orientation of the member 14 so that the user can optimize comfort while using the apparatus 10 and optimize control over a handheld device. In some embodiments, the pivotable member 14 is situated on the body 12 adjacent to the distal portion of a digit. In some embodiments, the pivotable member 14 is situated on the body 12 adjacent to the middle portion of a digit. In some embodiments, the pivotable member 14 is situated on the body 12 adjacent to the proximal portion of a digit.

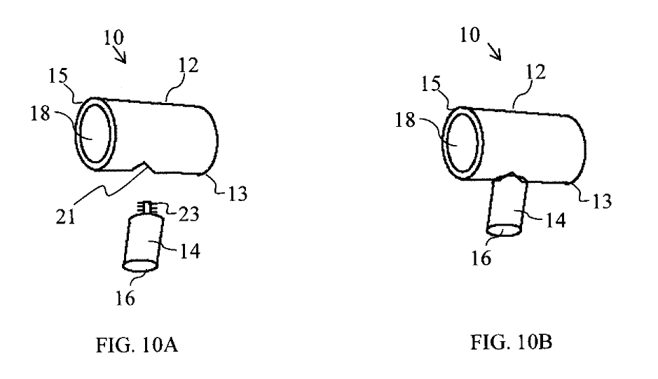

FIGS. 10A and 10B show perspective views of another embodiment of the apparatus 10 of the present disclosure in which the member 14 is removable. As shown in FIG. 10A, removable member 14 includes a fastener 23 and a surface 16. Any fastener 23 capable of removably connecting the member 14 to the body 12 can be used. Examples of suitable fasteners include, but are not limited to an adhesive, a screw, a clip, a snap, a hook, a magnet, a latch, a friction mechanism, or VELCRO®. In an embodiment, the removable member 14 is connected to the body 12 by positioning the fastener 23 into a recess 21. In an embodiment, the recess 21 can be situated anywhere along the longitudinal length of the fastener 23 from the proximal end 13 to the distal end 15. FIG. 8B shows removable member 14 removably connected to the body 12. In an embodiment, the member 14 is removable. In such embodiments, the member 14 can be detached and removed from the body 12. In an embodiment, the member 14 is replaceable. In such embodiments, the member 14 can be detached and removed from the body 12, and subsequently replaced with another member 14. In an embodiment, the member 14 is relocatable (not shown) from a first position on the body 12 to a second position on the body 12. By making the member 14 relocatable on the body 12, a user of the apparatus 10 of the present disclosure can place the member 14 on the body 12 in a position that is most effective for the user to manipulate and improve user control of the handheld device. In an embodiment, the relocatable member 14 allows the user to custom position the member 14 anywhere on the body 12 between the proximal end 13 and the distal end 15.

As noted above, in some embodiments, the removable member 14 allows a first member 14 to be removed and replaced with a second member 14. In some embodiments, the first member 14 and the second member 14 can be substantially the same (e.g., replaceable). In other embodiments, the first member 14 and the second member 14 can be different (e.g., interchangeable, upgradable). For example, when a user of the apparatus 10 changes handheld devices, the user may remove first member 14 having a first diameter, and replace the first member 14 with a second member 14 having a second diameter.

In embodiments, an apparatus 10 of the present disclosure for improving ergonomics of use of a handheld device can be used for reducing the likelihood of injury while using a handheld device. In such embodiments, the apparatus 10 of the present disclosure for reducing the likelihood of injury while using a handheld device comprises a body 12 configured to receive the digit, a member 14 situated on the body 12 adjacent to a distal portion of the digit. The member 14 is designed to be positioned between the digit and the handheld device so that repetitive contact between the member 14 and the handheld device can be made, but made in such a way that alters the mechanical vector of force transfer to minimize strain and stress. This way, repetitive contact between the member and the handheld device transfers a first force from the digit to the handheld device while minimizing or beneficially altering the impact of a second force being transferred from the handheld device to the digit. Without wishing to be bound by theory, it is believed that by minimizing or beneficially altering the impact of the second force being transferred from the handheld device to the digit, the likelihood of injury to the digit is reduced. Without wishing to be bound by theory, it is believed that minimizing or beneficially altering the impact of repetitive force transferred from the handheld device to the digit reduces the likelihood of receiving a neuromuscular disorder or arthritic disorder associated with repetitive unnatural hand and digit posturing. In an embodiment, repetitive contact between the member 14 and the handheld device maximizes the transfer of a first force from the digit to the handheld device while minimizing or beneficially altering the transfer of a second force from the handheld device to the digit. In an embodiment, repetitive contact between the member 14 and the handheld device allows a first sufficient force to be transferred to the handheld device to activate the responsive portion of the handheld device while preventing a second sufficient force from being transferred to the digit to cause injury to the digit or hand or wrist. In an embodiment, minimizing or beneficially altering the impact of force transferred from the handheld device to the digit reduces the likelihood of injury to the digit.

In an embodiment, the apparatus 10 of the present disclosure can be used for reducing the likelihood of injury to a digit while using a handheld device. In an embodiment, the apparatus 10 of the present disclosure can be used for reducing the likelihood of injury to a thumb while using a handheld device. In an embodiment, the apparatus 10 of the present disclosure can be used for reducing the likelihood of injury to an index digit while using a handheld device. In an embodiment, the apparatus 10 of the present disclosure can be used for reducing the likelihood of injury to a pointer digit while using a handheld device. In an embodiment, the apparatus 10 of the present disclosure can be used for reducing the likelihood of injury to a ring digit while using a handheld device. In an embodiment, the apparatus 10 of the present disclosure can be used for reducing the likelihood of injury to a pinky while using a handheld device. In an embodiment, the apparatus 10 of the present disclosure can be used for reducing the likelihood of injury to a hand while using a handheld device. In an embodiment, the apparatus 10 of the present disclosure can be used for reducing the likelihood of injury to a wrist while using a handheld device.

Without wishing to be bound by theory, it is believed that individuals with a physical limitation associated with the hand or wrist, such as carpal tunnel syndrome, or other neuromuscular or arthritic disorders, have decreased access to handheld devices. For instance, a physical limitation of the hand or neuromuscular or arthritic disorder can make it difficult for an individual to exercise sufficient motor control of their digits to precisely stroke the miniature responsive portions typically used to interface with a handheld device. Inadequate motor control can also result from the unnatural digit posturing required to interface with handheld devices. Namely, because the surface area of a typical responsive portion of a handheld device is a fraction of the size of the surface area of a typical size digit, natural digit or thumb movements about the axes of rotation of the joints of the digit or thumb are likely to cause undesirable results while using handheld devices. In particular, the larger surface area of the digit or thumb is likely to trigger multiple responsive portions of a handheld device when the digit or thumb is moved in a natural posture into contact with a responsive portion of a handheld device. In order to interface with a handheld device with greater accuracy and less frustration, handheld device users resort to constrained or unnatural posturing of their digits or thumbs in an effort to contact the responsive portion of the handheld device with a portion of the tip of the digit or thumbtip that has the smallest surface area. This often requires an unnatural or awkward posturing of the hand and thumb or digit. Whereas a natural digit or thumb movement would result in the digit or thumb being substantially parallel to the handheld device surface upon contact with the handheld device, an unnatural digit or thumb movement would result in the digit or thumb being substantially perpendicular to the handheld device surface upon contact so that the tip of the digit portion having the smaller surface area contacts the handheld device, thereby leading to improved accuracy.

Individuals having a physical limitation associated with the hand may also experience pain as they try to coordinate their muscles to precisely stroke the miniature responsive portions of handheld devices. It has also been observed that repetitive contact between the digits or thumbs and the miniature responsive portions on handheld devices can exacerbate discomfort or a symptom associated with a physical limitation associated with the hand, such as carpal tunnel syndrome, or other arthritic or neuromuscular disorders. It is believed that numbness and pain in the thumb and joints of the hand are symptoms caused by or exacerbated by the repetitive stress of, or unnatural movements required by, using a handheld electronic device. Use of such devises can cause symptoms such as pain, numbness and weakness and other injuries such as tendonitis or arthritis, even in an otherwise fully healthy individual with no pre-existing neuromuscular or arthritic disorder or pre-existing physical limitation.

Thus, individuals having a physical limitation associated with the hand are believed to have decreased access to handheld devices due at least in part to the inadequate motor control over their digits needed to precisely and repetitively stroke the miniature responsive portions of handheld devices or due at least in part to superimposed painful conditions resulting from repetitive strain of using a handheld device.

In an embodiment, an apparatus of the present disclosure is provided for improving the ergonomics of a handheld device. In such embodiments, the apparatus of the present disclosure for improving ergonomics of a handheld device can be used to improve a user's motor control of a handheld device. In an embodiment, an apparatus of the present disclosure is provided for improving a user's motor control of a handheld device. In an embodiment, an apparatus of the present disclosure for improving the motor control of a handheld device can be used to improve the motor control of handheld devices for users with a physical limitation associated with the hand or to potentially diminish the likelihood that the user will develop symptoms or an exacerbated diagnosis by using such a handheld device. In an embodiment, an apparatus for improving the motor control of handheld devices comprises a body configured to conform to a digit and a member connected to the body positioned adjacent to a distal portion of the digit, wherein the positioning of the member adjacent to the distal portion of the digit allows the digit to maintain a more natural and neutral position when the digit moves the member into contact with a responsive portion of a handheld device. In an embodiment, the natural position comprises a position substantially parallel to a major surface of the handheld device. In an embodiment, the natural position comprises a position substantially parallel to a longitudinal axis of a handheld device. In an embodiment, an apparatus for improving motor control of a handheld device comprises a body configured to conform to a digit, wherein when the body conforms to the digit the body allows each joint of the digit to move freely about its maximum range of natural motion, and a member connected to the body adjacent to a distal portion of the digit for transferring force from the digit to a responsive portion of a handheld device, wherein the positioning of the member adjacent to the distal portion of the digit allows the digit to maintain a natural position when the member transfers the force from the digit to the responsive portion of the handheld device. In an embodiment, the digit comprises a thumb. In an embodiment, the digit comprises an index digit. In an embodiment, the digit comprises a pointer digit. In an embodiment, the digit comprises a pinky digit. In an embodiment, the digit comprises a middle digit. In an embodiment, the digit comprises a plurality of digits.

In some embodiments, when the body is conformed to the digit, the body allows a joint of the digit to move about a complete range of motion of the joint. In some embodiments, the joint comprises a distal inter-phalangeal joint. In some embodiments, the joint comprises a proximal inter-phalangeal joint. In some embodiments, the joint comprises a metacarpo-phalangeal joint.

In some embodiments, when the body is conformed to the digit, the body allows the distal inter-phalangeal joint to move about its complete range of motion. In some embodiments, when the body is conformed to the digit, the body allows the proximal inter-phalangeal joint to move about its complete range of motion. In some embodiments, when the body is conformed to the digit, the body allows the metacarpo-phalangeal joint to move about its complete range of motion.

In some embodiments, the body can be configured to conform to an entire digit.

In some embodiments, the body can be configured to conform to a portion of the digit. In an embodiment, the portion of the digit comprises a distance between a tip of the digit and the distal inter-phalangeal joint. In an embodiment, the portion of the digit comprises a skin surface surrounding a distal phalanx. In an embodiment, the portion of the digit comprises a distance between a tip of the digit and the proximal inter-phalangeal joint. In an embodiment, the portion of the digit comprises a skin surface surrounding the distal phalanx and a middle phalanx. In an embodiment, the portion of the digit comprises a distance between a tip of the digit and a proximal phalanx. In an embodiment, the portion of the digit comprises a skin surface surrounding the distal phalanx, the middle phalanx, and the proximal phalanx.

In some embodiments, the body can be configured to conform to a portion of the digit comprising a distal phalanx. In some embodiments, the body can be configured to conform to a portion of the digit comprising a middle phalanx. In some embodiments, the body can be configured to conform to a portion of the digit comprising a proximal phalanx. In at least one embodiment, the body can be configured to conform to a portion of the digit comprising the distal phalanx, the middle phalanx, the proximal phalanx, or combinations thereof. In at least one embodiment, the body can be configured to conform to the distal phalanx, the middle phalanx, the proximal phalanx, or combinations thereof, so that when the body is conformed to the digit, the body allows the distal inter-phalangeal joint, the proximal inter-phalangeal joint, and the metacarpo-phalangeal joint to each move about its complete range of motion.

In some embodiments, a physical limitation comprises an injury such as, but not limited to, symptoms of pain, numbness, tingling, weakness, inflammation. In some embodiments, a physical limitation comprises a disease. In some embodiments, a physical limitation comprises a disorder. In some embodiments, a physical limitation comprises a deformity. In at least one embodiment, a physical limitation associated with the hand comprises an injury, a disease, a disorder, a deformity, or a combination thereof.

In an embodiment, an apparatus 10 of the present disclosure can be used for reducing an effective surface area of a tip of the digit. It is believed that reducing the effective surface area of the tip of the digit allows a user to activate a first responsive portion of the handheld device while minimizing the frequency of activating a second responsive portion of the handheld device, thereby improving a user's accuracy while using the handheld device by minimizing frequency of errors while using the handheld device. It is believed that by reducing the effective surface area of a tip of the digit, the apparatus 10 of the present disclosure can improve user control over a handheld device. In an embodiment, the apparatus 10 of the present disclosure for reducing the effective surface area of a tip of the digit can improve the accuracy of using a handheld device. In an embodiment, the apparatus 10 of the present disclosure for reducing the effective surface area of a tip of the digit can improve the speed of using a handheld device. In an embodiment, the apparatus 10 of the present disclosure for reducing the effective surface area of a tip of the digit can reduce error while using a handheld device.

In some embodiments, an apparatus 10 of the present disclosure for reducing an effective surface area of a tip of the digit comprises a body 12 configured to conform to a digit, and a member positioned on the body 12 adjacent to the digit, the member 14 being configured to be positioned between the digit and a handheld device. In an embodiment, the body 12 is configured to conform to a distal portion of the digit and the member 14 is configured to be positioned between the distal portion of the digit and a handheld device. In an embodiment, the body 12 is configured to conform to a tip of the digit and the member 14 is configured to be positioned between the tip of the digit and a handheld device. In some embodiments, the member 14 is configured to be positioned between the digit and a responsive portion of a handheld device. In some embodiments, the member 14 is configured to be positioned between a distal portion of the digit and a responsive portion of the handheld device. In some embodiments, the member 14 is configured to be positioned between a tip of the digit and a responsive portion of the handheld device.

In some embodiments, the member 14 has a contact surface 16 having a surface area less than about a surface area of an average size tip of the digit so as to reduce the effective surface area of the tip of the digit. In some embodiments, the member 14 has a contact surface 16 having a surface area less than about three-quarters of a surface area of an average size tip of the digit so as to reduce the effective surface area of the tip of the digit. In some embodiments, the member 14 has a contact surface 16 having a surface area less than about half of a surface area of an average size tip of the digit so as to reduce the effective surface area of the tip of the digit. In some embodiments, the member 14 has a contact surface 16 having a surface area less than about a third of a surface area of an average size tip of the digit so as to reduce the effective surface area of the tip of the digit. In some embodiments, the member 14 has a contact surface 16 having a surface area less than about a quarter of a surface area of an average size tip of the digit so as to reduce the effective surface area of the tip of the digit. In some embodiments, the member 14 has a contact surface 16 having a surface area less than about a centimeter so as to reduce the effective surface area of the tip of the digit. In some embodiments, the member 14 has a contact surface 16 having a surface area less than about a half centimeter so as to reduce the effective surface area of the tip of the digit.

In an embodiment, reducing the effective surface area of the tip of the digit allows a user of the handheld device to activate a first intended responsive portion of the handheld device while minimizing the frequency of activating a second unintended responsive portion of the handheld device while trying to activate the first intended responsive portion. In an embodiment, reducing the effective surface area of the digit with the apparatus 10 of the present disclosure also allows a user to activate an intended responsive portion of a handheld device without activating an adjacent unintended responsive portion of the handheld device. In an embodiment, reducing the effective surface area of the digit with the apparatus 10 of the present disclosure allows a user to avoid activating an unintended responsive portion of the handheld device while attempting to activate an adjacent intended responsive portion of the handheld device.

All patents, patent applications, and published references cited herein are hereby incorporated by reference in their entirety. It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An apparatus for using a handheld device comprising:
a body configured to conform to a digit; and
a member connected to the body adjacent to the digit;
wherein bringing the member into contact with the handheld device transfers force from the digit to the handheld device.

2. The apparatus of claim 1, wherein the member can be used to perform on the handheld device a gesture, typing, tapping, pressing, writing, drawing, painting, switching, sliding, texting, selecting, inputting, holding, or combinations thereof.

3. The apparatus of claim 1, further comprising one or more additional members situated on the body.

4. The apparatus of claim 1, wherein the member is removable or replaceable.

5. The apparatus of claim 1, wherein the member is relocatable.

6. The apparatus of claim 1, wherein the member is rotatable or pivotable.

7. An apparatus for using a handheld device comprising:
a body configured to conform to a digit, the body having a proximal end, a distal end, and an opening between the proximal and distal ends for receiving the digit; and
a member connected to the body adjacent to a distal portion of the digit, wherein when the digit moves the member into contact with the handheld device, the member transfers force from the digit to the handheld device.

8. The apparatus of claim 7, wherein the body further includes a covering at the distal end of the body to minimize displacement of the body from its position as conformed to the digit.

9. The apparatus of claim 7, wherein the member can be used to perform on the handheld device a gesture, typing, tapping, pressing, writing, drawing, painting, switching, sliding, texting, selecting, inputting, holding, or combinations thereof.

10. The apparatus of claim 7, further comprising one or more additional members situated on the body, wherein bringing each of the one or more additional members into contact with the handheld device transfers force from the digit to the handheld device to activate a responsive portion of the handheld device.

11. The apparatus of claim 7, wherein the member is removable or replaceable.

12. The apparatus of claim 7, wherein the member is relocatable.

13. The apparatus of claim 7, wherein the member is rotatable or pivotable.

14. An apparatus for using a handheld device comprising:
a body configured to conform to a digit; and
a member connected to the body adjacent to a tip of the digit of the digit, the member being defined by a length and a cross-sectional area sufficient to allow the member to transfer force from the digit to the handheld device when the digit moves the member into contact with the handheld device.

15. The apparatus of claim 14, wherein the member can be used to perform on the handheld device one of a gesture, typing, tapping, pressing, writing, drawing, painting, switching, sliding, texting, selecting, inputting, holding, or combinations thereof.

16. The apparatus of claim 14, wherein the body extends from a sleeve of a user.

17. The apparatus of claim 14, further comprising one or more additional members situated on the body, wherein bringing each of the one or more additional members into contact with the handheld device transfers force from the digit to the handheld device to activate a responsive portion of the handheld device.

18. The apparatus of claim 14, wherein the member is removable or replaceable.

19. The apparatus of claim 14, wherein the member is relocatable.

20. The apparatus of claim 14, wherein the member is rotatable or pivotable.
